(19) United States
(12) Patent Application Publication
(10) Pub. No.: US 2002/0004843 A1
(43) Pub. Date: Jan. 10, 2002

(54) System, device, and method for bypassing network changes in a routed communication network

(76) Inventors: Loa Andersson, Alvsjo (SE); Elwyn Davies, Soham (GB); Tove Madsen, Transgund (SE)

Correspondence Address: BROMBERG & SUNSTEIN LLP, 125 SUMMER STREET, BOSTON, MA, 02110-1618, US

(21) Appl. No.: 09/747,496

(22) Filed: Dec. 21, 2000

Related U.S. Application Data
(60) Provisional application No. 60/216,048, filed on Jul. 5, 2000.

(51) Int. Cl. G06F 15/173; G06F 15/16

(52) U.S. Cl. 709/238; 709/203

(57) ABSTRACT

A system, device, and method for bypassing network changes in a communication network pre-computes recovery paths to protect various primary paths. A fast detection mechanism is preferably used to detect network changes quickly, and communications are switched over from the primary paths to the recovery paths in order to bypass network changes. Forwarding tables are preferably frozen as new primary paths are computed, and communications are switched over from the recovery paths to the new primary paths in a coordinated manner in order to avoid temporary loops and invalid routes. New recovery paths are computed to protect the new primary paths.

### PRIORITY

The present patent application claims priority from the following commonly-owned United States provisional patent application, which is hereby incorporated herein by reference in its entirety:

U.S. patent application Ser. No. 60/216,048 entitled SYSTEM, DEVICE, AND METHOD FOR BYPASSING NETWORK FAILURES IN A ROUTED COMMUNICATION NETWORK, filed on Jul. 5, 2000 in the names of Loa Andersson, Elwyn Davies, and Tove Madsen.

### CROSS-REFERENCE TO RELATED APPLICATIONS

The present patent application may be related to the following commonly-owned United States utility patent applications, which are hereby incorporated herein by reference in their entireties:

U.S. patent application Ser. No. 09/458,402 entitled FAST PATH FORWARDING OF LINK STATE ADVERTISEMENTS, filed on Dec. 10, 1999 in the name of Bradley Cain;

U.S. patent application Ser. No. 09/458,403 entitled FAST PATH FORWARDING OF LINK STATE ADVERTISEMENTS USING REVERSE PATH FORWARDING, filed on Dec. 10, 1999 in the name of Bradley Cain;

U.S. patent application Ser. No. 09/460,321 entitled FAST PATH FORWARDING OF LINK STATE ADVERTISEMENTS USING A MINIMUM SPANNING TREE, filed on Dec. 10, 1999 in the name of Bradley Cain; and

U.S. patent application Ser. No. 09/460,341 entitled FAST PATH FORWARDING OF LINK STATE ADVERTISEMENTS USING MULTICAST ADDRESSING, filed on Dec. 10, 1999 in the name of Bradley Cain.

1. Field of the Invention

The present invention is related generally to communication systems, and more particularly to bypassing network failures in a routed communication network.

2. Background of the Disclosure

An Internet Protocol (IP) routed network can be described as a set of links and nodes that operate at Layer 3 (L3) of a layered protocol stack, generally in accordance with the OSI reference model. Failures in this kind of network can affect either nodes or links. Identifying a link failure is straightforward in most cases. On the other hand, diagnosing a node failure might be simple, but can be extremely complicated.

Any number of problems can cause failures, anything from a physical link breaking or a fan malfunctioning through to code executing erroneously.

Congestion could be viewed as a special case of failure, due to a heavy load on a link or a node. The nature of congestion is, however, often transient.

In any layered network model, failures can be understood as relating to a certain layer. Each layer has some capability to cope with failures. If a particular layer is unable to overcome a failure, that layer typically reports the failure to a higher layer that may have additional capabilities for coping with the failure. For example, a physical link between two nodes is broken, it is possible to have another link on standby and switch the traffic over to this other link. If the link control logic (L2) fails, it is possible to have an alternate in place. If all of these methods are unable to resolve the problem, the failure is passed on to the network layer (L3).

Lower layer protection schemes are generally based on media specific failure indications, such as loss of light in a fiber. When such a failure is detected, the traffic is switched over to a pre-configured alternate link. Normally, the new link is a twin of the failing one, i.e., if one fiber breaks, another with the same characteristics (with the possible exception of using a separate physical path) replaces it.

A strength of this type of protection is that it is fast, effective and simple. A weakness is that it is strictly limited to one link layer hop between two nodes, and once it is used, the protection plan is of no further utility until the original problem is repaired.

End to end protection is a technology that protects traffic on a specific path. It involves setting up a recovery path that is put into operation if the primary path fails. The switch over is typically made by the node originating the connection and triggered by a notification sent in-band to this node. The technology is normally used in signaled and connection oriented networks, such as Asynchronous Transfer Mode (ATM).

A strength of this type of protection is that it is possible to decide at a very fine granularity, which traffic to protect, and which not to protect. A weakness is that, if it used in IP networks, the signaling that traverses the network to the ingress node will be processed in every node on its way. This processing will take some time and the switch over will not be as fast as in the lower layer alternatives. Also, if the ratio of protected traffic is high, it might lead to signaling storms, as each connection has to be signaled independently.

End to end path protection of traffic in connectionless networks, such as IP networks, is virtually impossible. One reason for this is that there are no “paths” per se that can be protected.

In communication networks based on packet forwarding and a connectionless paradigm, a period of non-connectivity (looping or black holing) might occur after a change in the Layer 3 (L3) network. In an OSPF (Open Shortest Path First) implementation as described in an Internet Engineering Task Force (IETF) Request For Comments (RFC) 2328 entitled OSPF Version 2 by J. Moy dated April 1998, which is hereby incorporated herein by reference in its entirety and referred to hereinafter as the OSPF specification, the period of non-connectivity might be as long as 30-40 seconds. Similar periods of non-connectivity might occur in an IS-IS (Integrated Intermediate System to Intermediate System) implementation as described in an Internet Engineering Task Force (IETF) Request For Comments (RFC) 1195 entitled Use of OSI IS-IS for Routing in TCP/IP and Dual Environments by R. Callon dated December 1990, which is hereby incorporated herein by reference in its entirety, or in a BGP (Border Gateway Protocol) implementation as described in an Internet Engineering Task Force (IETF) Request For Comments (RFC) 1771 entitled A Border Gateway Protocol 4 (BGP-4) by Y. Rekhter et al. dated March 1995, which is hereby incorporated herein by reference in its entirety.

### SUMMARY OF THE DISCLOSURE

In accordance with one aspect of the invention, recovery paths are precomputed for protecting various primary paths. The recovery paths are typically installed in the forwarding table at each relevant router along with the primary paths so that the recovery paths are available in the event of a network change. A fast detection mechanism is preferably used to detect a network change. Communications are switched over from a primary path to a recovery path in the event of a network change in order to bypass the network change.

In accordance with another aspect of the invention, new primary paths are computed following the switch over from the primary path to the recovery path. Forwarding tables are preferably frozen as the new primary paths are computed, and communications are switched over from the recovery paths to the new primary paths in a coordinated manner in order to avoid temporary loops and invalid routes.

In accordance with yet another aspect of the invention, new recovery paths are computed after the new primary paths are computed. The new recovery paths may be computed either before or after communications are switched over from the recovery paths to the new primary paths.

### BRIEF DESCRIPTION OF THE DRAWINGS

The foregoing and other objects and advantages of the invention will be appreciated more fully from the following further description thereof with reference to the accompanying drawings wherein:

FIG. 1 is a block diagram showing an exemplary communication system in which the disclosed bypass mechanism is used to bypass network failures;

FIG. 2 shows a representation of a forwarding table having a primary path and a corresponding recovery path in accordance with an embodiment of the present invention;

FIG. 3A shows a representation of the forwarding table after the recovery path is activated by removal of the primary path in accordance with an embodiment of the present invention;

FIG. 3B shows a representation of the forwarding table after the recovery path is activated by blockage of the primary path in accordance with an embodiment of the present invention;

FIG. 3C shows a representation of the forwarding table after the recovery path is activated by marking the recovery path as the preferred path in accordance with an embodiment of the present invention;

FIG. 4 shows a representation of the full protection cycle in accordance with an embodiment of the present invention;

FIG. 5 is a logic flow diagram showing exemplary logic for performing a full protection cycle in which the new recovery paths are computed before the switch over to the new primary paths in accordance with an embodiment of the present invention;

FIG. 6 is a logic flow diagram showing exemplary logic for performing a full protection cycle in which the new recovery paths are computed after the switch over to the new primary paths in accordance with an embodiment of the present invention;

FIG. 7 is a logic flow diagram showing exemplary logic for computing a set of recovery paths in accordance with an embodiment of the present invention;

FIG. 8 is a logic flow diagram showing exemplary logic for performing a switch over from the primary path to the recovery path in accordance with an embodiment of the present invention;

FIG. 9 is a logic flow diagram showing exemplary logic for coordinating activation of the new primary paths using timers in accordance with an embodiment of the present invention;

FIG. 10 is a logic flow diagram showing exemplary logic for coordinating activation of the new primary paths using a diffusion mechanism in accordance with an embodiment of the present invention;

FIG. 11 is a logic flow diagram showing exemplary logic for coordinating activation of the new primary paths by a slave node in accordance with an embodiment of the present invention; and

FIG. 12 is a logic flow diagram showing exemplary logic for coordinating activation of the new primary paths by a master node in accordance with an embodiment of the present invention.

### DETAILED DESCRIPTION OF A PREFERRED EMBODIMENT

A bypass mechanism for quickly bypassing network changes is disclosed. The disclosed bypass mechanism is useful generally, but is particularly useful in high-speed IP or IP/MPLS (MultiProtocol Label Switching) networks that are used for realtime sensitive applications in which network changes must be bypassed quickly. The disclosed bypass mechanism is not limited to any particular mapping between network layer (L3) topology and lower layer topologies. The disclosed bypass mechanism preferably does not interfere with layer protection mechanisms at other layers, such as SDH/SONET.

In a typical embodiment of the present invention, the communication network is a large scale (100 nodes or larger) L3 routed IP network, in which traffic is typically forwarded based on the L3-header information (mainly the destination IP address) according to a predetermined routing protocol, such as OSPF (Open Shortest Path First) or IS-IS (Integrated Intermediate System to Intermediate System). The network may be MPLS enabled, and some traffic might be forwarded on Label Switched Paths (LSPs), mainly for traffic engineering purposes. Thus, traffic may be forwarded on L3 information, MPLS labels, or both. MPLS is described in an Internet Engineering Task Force internet draft document draft-ietf-mpls-arch-06.txt entitled Multiprotocol Label Switching Architecture by Eric C. Rosen et al. dated August 1999 and in an Internet Engineering Task Force internet draft document draft-ietf-mpls-framework-05.txt entitled A Framework for Multiprotocol Label Switching by R. Callon et al. dated September 1999, both of which are hereby incorporated herein by reference in their entireties.

Each network node typically computes various network routes using a predetermined routing protocol (e.g., OSPF or IS-IS). Each node typically maintains these routes in a routing table. Each node typically computes various communication paths for routing L3 traffic within the communication network, for example, based upon the network routes in the routing table and/or MPLS tunnels based upon traffic engineering concerns. For convenience, such communication paths are referred to hereinafter as primary paths or primary routes. Each network node typically includes the primary paths in a forwarding table, which is used by the network node to forward L3 traffic (e.g., based upon destination IP address or MPLS label) between interfaces of the network node.

Within the communication network, various network changes can cause the network nodes to compute or re-compute primary paths. The network changes may include such things as link failures, node failures, and route changes. For convenience, these network changes may be referred to hereinafter generally as network failures, since they are all treated by the routing protocol as network failures. A primary purpose of computing or re-computing primary paths in the even of a network failure is to bypass the network failure.

In an embodiment of the present invention, the network nodes pre-compute various alternate paths, such as non-shortest-path routes or MPLS tunnels, for bypassing potential network changes (e.g., link failures, node failures, route changes). For convenience, such alternate paths are referred to hereinafter as recovery paths or recovery routes. Each network node typically includes such pre-computed recovery paths along with the primary paths in the forwarding table. The recovery paths are typically marked as non-preferred or lower priority paths compared to the primary paths so that the primary paths, and not the recovery paths, are used for forwarding packets during normal operation.

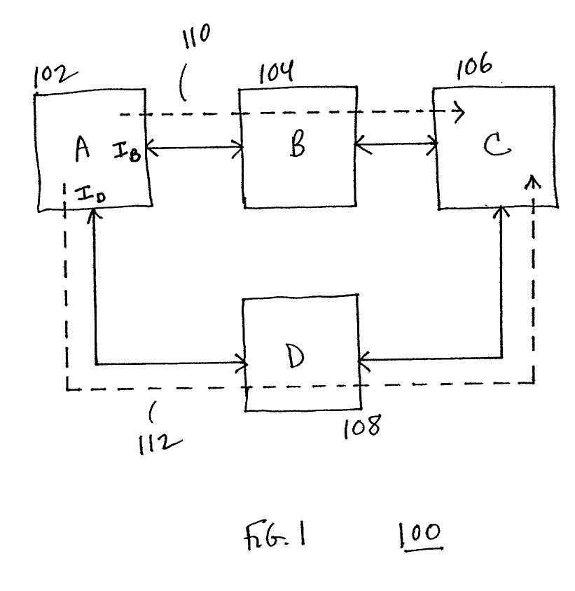

FIG. 1 shows an exemplary communication network 100 in which the disclosed bypass mechanism is used to bypass network failures. In this example, Node A 102 is coupled to Node C 106 through Node B 104, and is also coupled to Node C 106 through Node D 108. Using a predetermined routing protocol and routing information obtained from Node B 104, Node C 106, and Node D 108, Node A 102 has computed a primary path 110 to Node C 106 through Node B 104, and has also computed a recovery path 112 to Node C 106 through Node D 108 for bypassing a failure of the primary path 110. It should be noted that the primary path 110 may fail anywhere along its length, including a failure within Node A 102, a failure of the link between Node A 102 and Node B 104, a failure of Node B 104, a failure of the link between Node B 104 and Node C 106, and a failure within Node C 106.

The primary path 110 and the recovery path 112 are associated with different outgoing interfaces of Node A 102. Solely for convenience, the primary path 110 is said to be associated with an outgoing interface I_{B} of Node A 102, and the recovery path 112 is said to be associated with an outgoing interface I_{D} of Node A 102. Thus, in order to forward packets to Node C 106 over the primary path 110, Node A 102 would forward the packets to Node B 104 over its outgoing interface I_{B}. In order to forward packets to Node C 106 over the recovery path 112, Node A 102 would forward the packets to Node D 108 over its outgoing interface I_{D}.

Node A 102 maintains a forwarding table for mapping each destination address to a particular outgoing interface. In this example, the forwarding table of Node A 102 includes an entry that maps destination Node C 106 to outgoing interface I_{B} for the primary path 110, and also includes an entry that maps destination Node C 106 to outgoing interface I_{D} for the recovery path 112.

FIG. 2 shows a representation of a forwarding table 200 maintained by Node A 102. Each forwarding table entry maps a destination 202 to an outgoing interface 204. A marker 206 on each forwarding table entry is used herein for explanatory purposes. The forwarding table 200 includes an entry 210 that corresponds to the primary path 110 and maps destination Node C 106 to outgoing interface I_{B}, and another entry 220 that corresponds to the recovery path 112 and maps destination Node C 106 to outgoing interface I_{D}. The entry 210 is marked as the preferred (primary) path to Node C 106, while the entry 220 is marked as the alternate (recovery) path to Node C 106. Thus, the entry 210 is used for forwarding packets to Node C 106 during normal operation, so that packets are forwarded to Node C 106 over outgoing interface I_{B}.

The network nodes preferably use a fast detection mechanism for detecting network failures quickly (relative to a traditional failure detection mechanism). Upon detecting a network failure, the network nodes switch certain communications to one or more recovery paths in order to bypass the network failure, while communications unaffected by the network failure typically remain on the primary paths. The switch over to the recovery paths can be accomplished, for example, by removing the primary path from the forwarding table, blocking the primary path in the forwarding table, or marking the recovery path as a higher priority path than the primary path in the forwarding table (i.e., assuming the recovery paths are already installed in the forwarding table). The network nodes may switch all communications from a failed primary path to a recovery path, or may switch only a portion of communications from the failed primary path to the recovery path, perhaps using IP Differentiated Services (DiffServ) or other prioritization scheme to prioritize traffic. By detecting the network failure quickly and switching communications to pre-computed recovery paths, network failures are bypassed quickly.

For example, with reference again to FIG. 1, Node A 102 preferably monitors the primary path 110 using a fast detection mechanism. Upon detecting a failure of the primary path 110, Node A 102 switches some or all of the traffic from the primary path 110 to the recovery path 112. This typically involves inactivating the primary path 110 and activating the recovery path 112. This can be accomplished, for example, by removing the primary path from the forwarding table, blocking the primary path in the forwarding table, or marking the recovery path as a higher priority path than the primary path in the forwarding table.

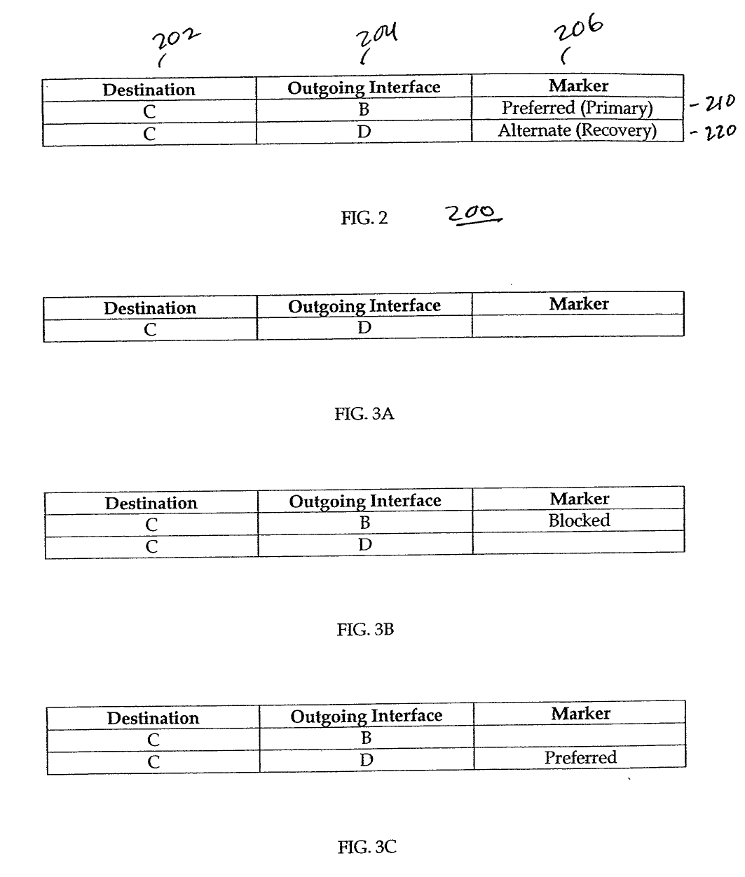

FIG. 3A shows a representation of the forwarding table 200 after the recovery path 112 is activated by removal of the primary path 110. With the primary path 110 removed, the recovery path 112 is the only entry in the forwarding table having Node C 106 as a destination. Thus, the recovery path 112 becomes the preferred path to Node C 106 by default.

FIG. 3B shows a representation of the forwarding table 200 after the recovery path 112 is activated by blockage of the primary path 110. Specifically, the primary path 110 is left in the forwarding table, but is marked so as to be unusable. With the primary path 110 blocked, the recovery path 112 becomes the preferred path to Node C 106 by default.

FIG. 3C shows a representation of the forwarding table 200 after the recovery path 112 is activated by marking the recovery path 112 as the preferred path to Node C 106.

After switching communications to the pre-computed recovery paths, the network nodes “reconverge” on a new set of primary paths, for example, based upon the predetermined routing protocol (e.g., OSPF or IS-IS). Reconvergence typically involves the network nodes exchanging updated topology information, computing the new set of primary paths based upon the topology information, and activating the new set of primary paths in order to override the temporary switch over to the recovery paths. This reconvergence can cause substantial information loss, particularly due to temporary loops and invalid routes that can occur as the network nodes compute the new set of primary paths and activate the new set of primary paths in an uncoordinated manner. This information loss negates some of the advantages of having switched to the recovery paths in the first place.

Thus, in order to reduce information loss during reconvergence following the switch over to the recovery paths, the network nodes preferably “freeze” their respective forwarding tables during the reconvergence process. Specifically, the network nodes use their respective frozen forwarding tables for forwarding packets while exchanging the updated topology information and computing the new set of primary paths in the background. In this way, the network nodes are able to compute the new set of primary paths without changing the forwarding tables and disrupting the actual routing of information. After all networks nodes have settled on a new set of primary paths, the network nodes activate the new set of primary paths in a coordinated manner in order to limit any adverse affects of reconvergence.

After the new primary paths are established, the network nodes typically compute new recovery paths. This may be done either before or after the switch over to the new primary paths. If the new recovery paths are computed before the switch over to the new primary paths, then the new recovery paths are available to bypass network failures, although the switch over to the new primary paths is delayed while the new recovery paths are computed. If the new recovery paths are computed after the switch over to the new primary paths, then the new primary paths are “unprotected” until the recovery paths are computed, although the switch over to the new primary paths is not delayed by the computation of the new recovery paths.

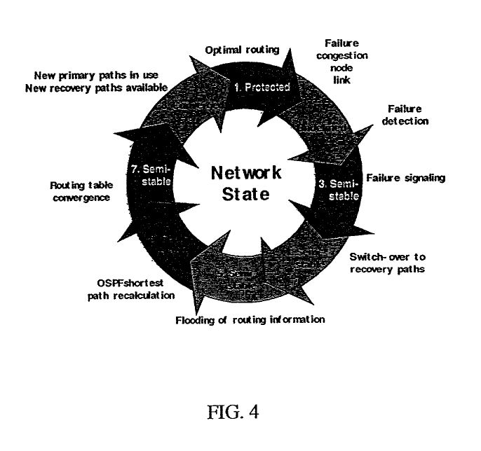

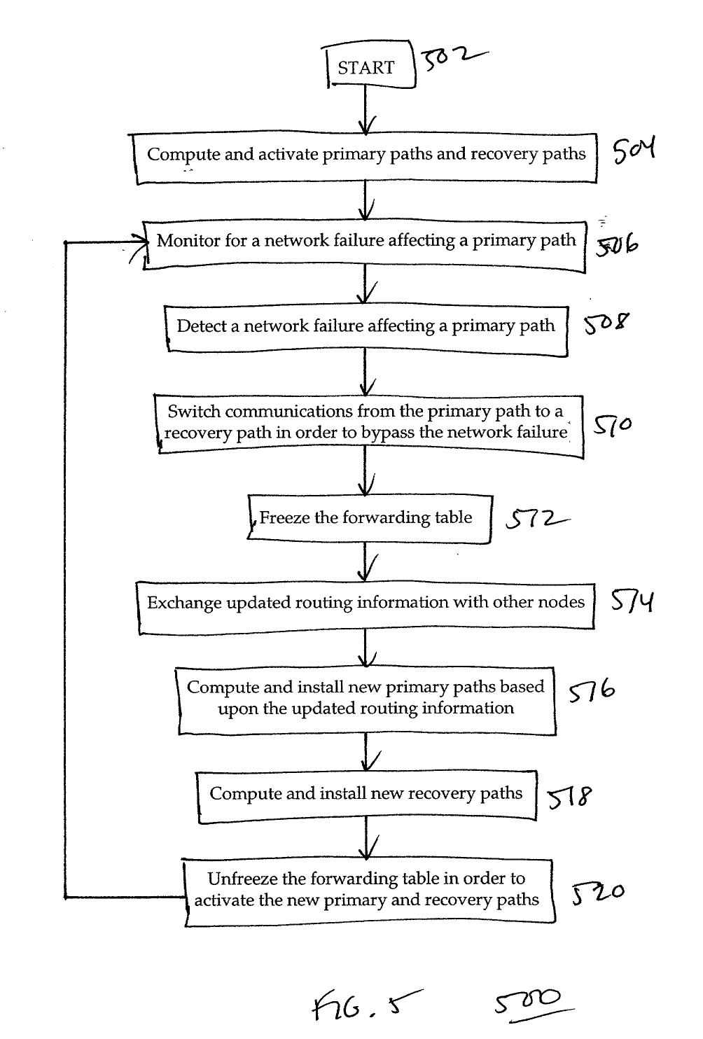

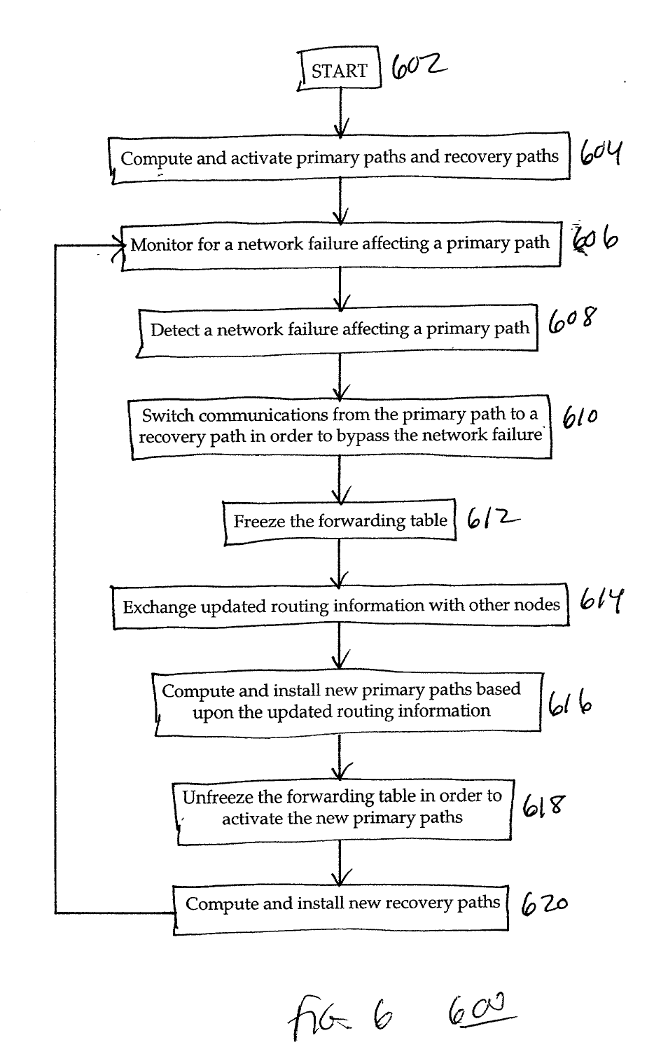

Thus, the disclosed bypass mechanism provides a “full protection cycle” that builds upon improvements and changes to the IP routed network technology. As depicted in FIG. 4, the “full protection cycle” consists of a number of states through which the network is restored to a fully operational state (preferably with protection against changes and failures) as soon as possible after a fault or change whilst maintaining traffic flow to a great extent during the restoration. Specifically, in the normal state of operation (state 1), traffic flows on the primary paths, with recovery paths pre-positioned but not in use. When a network failure occurs and is detected by a network node (state 2), the detecting node may signal the failure to the other network nodes (state 3), particularly if the detecting node is not capable of performing the switch over. When the failure indication reaches a node that is capable of performing the switch over (including the detecting node), that node performs the switch over to the recovery paths in order to bypass the network failure (state 4). The network nodes then reconverge on a new set of primary paths (states 5-7), specifically by exchanging routing information and computing new primary paths. During this reconvergence process, each node “freezes” its current forwarding table, including LSPs for traffic engineering (TE) and recovery purposes. The “frozen” forwarding table is used while the network converges in the background (i.e., while new primary paths are computed). Once the network has converged (i.e., all network nodes have completed computing new primary paths), the network nodes switch over to the new primary paths in a coordinated fashion (state 8). New recovery paths are computed either before switching over to the new primary paths (e.g., in states 5-7) of after switching over to the new primary paths (e.g., in state 8).

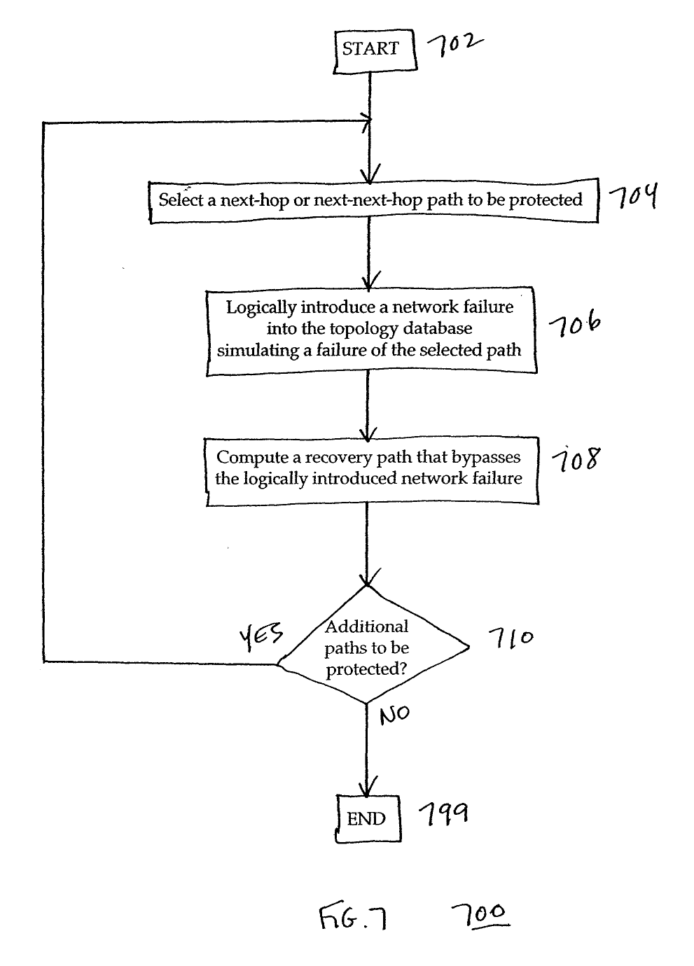

FIG. 5 shows exemplary logic 500 for performing a full protection cycle in which the new recovery paths are computed before the switch over to the new primary paths. Beginning at block 502, the logic computes and activates primary paths and recovery paths, in block 504. The logic monitors for a network failure affecting a primary path, in block 506. Upon detecting a network failure affecting a primary path, in block 508, the logic switches communications from the primary path to a recovery path in order to bypass the network failure, in block 510. The logic then freezes the forwarding table, in block 512. After freezing the forwarding table, in block 512, the logic exchanges routing information with the other nodes, in block 514, and computes and installs new primary paths based upon the updated routing information, in block 516. The logic computes and installs new recovery paths, in block 518, so that the new recovery paths are available for protection before the switch over to the new primary paths. The logic then unfreezes the forwarding table in order to activate both the new primary paths and the new recovery paths, in block 520. The logic recycles to block 506 to monitor for a network failure affecting a new primary path.

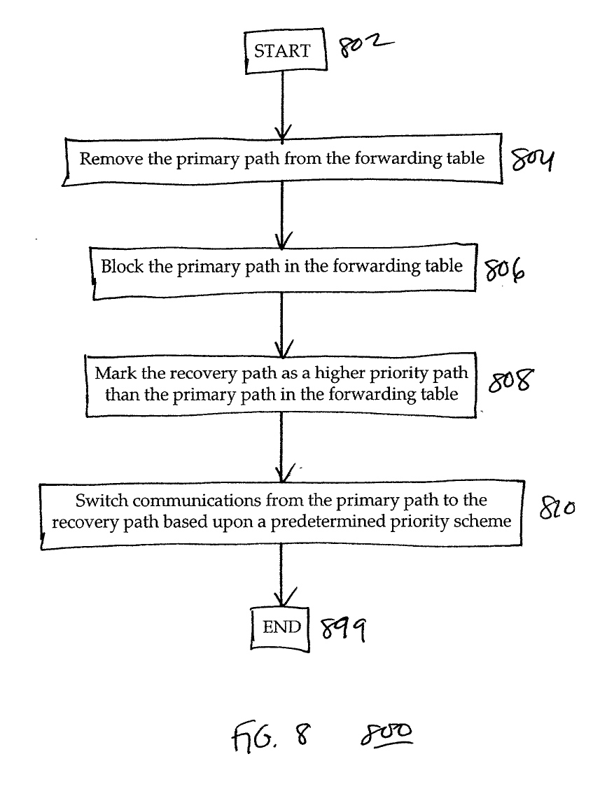

FIG. 6 shows exemplary logic 600 for performing a full protection cycle in which the new recovery paths are computed after the switch over to the new primary paths. Beginning at block 602, the logic computes and activates primary paths and recovery paths, in block 604. The logic then monitors for a network failure affecting a primary path, in block 606. Upon detecting a network failure affecting a primary path, in block 608, the logic switches communications from the primary path to a recovery path in order to bypass the network failure, in block 610. The logic then freezes the forwarding table, in block 612. After freezing the forwarding table, in block 612, the logic exchanges routing information with the other nodes, in block 614, and computes and installs new primary paths based upon the updated routing information, in block 616. The logic unfreezes the forwarding table in order to activate the new primary paths, in block 618. The logic then computes and installs new recovery paths, in block 620. The logic recycles to block 606 to monitor for a network failure affecting a new primary path.

Various aspects and embodiments of the present invention are discussed in more detail below.

Computing Primary Paths

Each network node computes various primary paths and installs the primary paths in its forwarding table. In a typical embodiment of the invention, the network nodes exchange routing information as part of a routing protocol. There are many different types of routing protocols, which are generally categorized as either distance-vector protocols (e.g., RIP) or link-state protocols (e.g., OSPF and IS-IS). Each network node determines the primary paths from the routing information, typically selecting as the primary paths the shortest paths to each potential network destination. For a distance-vector routing protocol, the shortest path to a particular destination is typically based upon hop count. For a link-state routing protocol, the shortest path to a particular destination is typically determined by a shortest-path-first (SPF) computation, for example, per the OSPF specification. Primary paths may also include MPLS tunnels that are established per constraint-based considerations, which may include other constraints beyond or instead of the shortest path constraint.

Computing Recovery Paths

In order to provide protection for the primary paths, the network nodes typically pre-compute recovery paths based upon a predetermined protection plan. The recovery paths are pre-computed so as to circumvent potential failure points in the network, and are only activated in the event of a network failure. Each recovery path is preferably set up in such a way that it avoids the potential failure it is set up to overcome (i.e., the recovery path preferably avoids using the same physical equipment that is used for the primary path that it protects). The network nodes typically install the recovery paths in the forwarding tables as non-preferred or lower priority routes than the primary paths so that the primary paths, and not the recovery paths, are used for forwarding packets during normal operation.

In an exemplary embodiment of the invention, a recovery path is calculated by logically introducing a failure into the routing database and performing a Shortest Path First (SPF) calculation, for example, per the OSPF specification. The resulting shortest path is selected as the recovery path. This procedure is repeated for each next-hop and ‘next-next-hop’. The set of ‘next-hop’ routers for a particular router is preferably the set of routers that are identified as the next-hop for all OSPF routes and TE LSPs leaving the router. The set of ‘next-next-hop’ routers for a particular router is preferably the union of the next-hop sets of the routers in the next hop set of the router setting up the recovery paths, but restricted to only routes and paths that pass through the router setting up the recovery paths.

One type of recovery path is a LSP, and particularly an explicitly routed LSP (ER-LSP). In the context of the present invention, a LSP is essentially a tunnel from the source node to the destination node that circumvents a potential failure point. Packets are forwarded from the source node to the destination node over the LSP using labels rather than other L3 information (such as destination IP address).

In order for a LSP to be available as a recovery path, the LSP must be established from the source node to the destination node through any intermediate nodes. The LSP may be established using any of a variety of mechanisms, and the present invention is in no way limited by the way in which the LSP is established.

One way to establish the LSP is to use a label distribution protocol. One label distribution protocol, known as the Label Distribution Protocol (LDP), is described in an Internet Engineering Task Force (IETF) internet draft document draft-ietf-mpls-ldp-11.txt entitled LDP Specification by Loa Andersson et al. dated August 2000, which is hereby incorporated herein by reference in its entirety. The LDP specification describes how an LSP is established. Briefly, if the traffic to be forwarded over the LSP is solely traffic that is forwarded on L3 header information, then a single label is used for the LSP. If the traffic to be forwarded over the LSP includes labeled traffic, then a label stack is used for the LSP. In order to use a label stack, the labels to be used in the label stack immediately below the tunnel label have to be allocated and distributed. The procedure to do this is simple and straightforward. First a Hello Message is sent through the tunnel. If the tunnel bridges several hops before it reaches the far end of the tunnel, a Targeted Hello Message is used. The destination node responds with a LDP Initialization message and establishes an LDP adjacency between the source node and the destination node. Once the adjacency is established, KeepAlive messages are sent through the tunnel to keep the adjacency alive. The source node sends Label Requests to the destination node in order to request one label for each primary path that uses label switching.

Another way to establish the LSP is described in an Internet Engineering Task Force (IETF) internet draft draft-ietf-mpls-cr-ldp-04.txt entitled Constraint-Based LSP Setup using LDP by B. Jamoussi et al. dated July 2000, which is hereby incorporated herein by reference in its entirety and is referred to hereinafter as CR-LDP.

Another way to establish the LSP is described in an Internet Engineering Task Force (IETF) internet draft draft-ietf-mpls-rsvp-lsp-tunnel-07.txt entitled RSVP-TE: Extensions to RSVP for LSP Tunnels by D. Awduche et al. dated August 2000, which is hereby incorporated herein by reference in its entirety and is referred to hereinafter as RSVP-TE.

Another way to establish the LSP is to use LDP for basic LSP setup and to use RSVP-TE for traffic engineering.

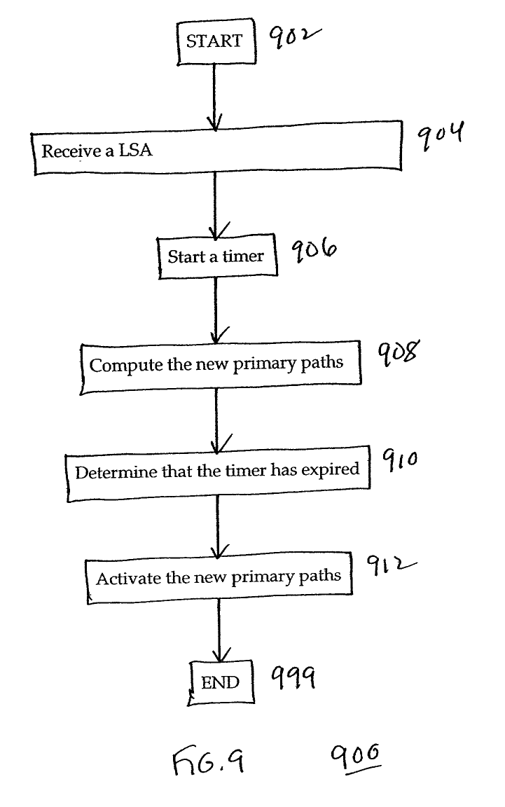

FIG. 7 shows exemplary logic 700 for computing a set of recovery paths. Beginning in block 702, the logic selects a next-hop or next-next-hop path to be protected, in block 704, logically introduces a network failure into the topology database simulating a failure of the selected path, in block 706, and computes a recovery path that bypasses the logically introduced network failure, in block 708. This is repeated for each next-hop and next-next-hop. Specifically, the logic determines whether additional paths need to be protected, in block 710. If additional paths need to be protected (YES in block 710), then the logic recycles to block 704 to compute a recovery path for another next-hop or next-next-hop path. If no additional paths need to be protected (NO in block 710), then the logic 700 terminates in block 799.

Network in Protected State (State 1)

In the protected state, the routing protocol has converged to a steady state, and each node has established the appropriate routing and forwarding tables. The primary paths have been established, and the recovery paths have been computed and installed in the forwarding tables. The nodes monitor for network failures.

Link/Node Failure Occurs (State 2)

As discussed above, an Internet Protocol (IP) routed network can be described as a set of links and nodes that operate at Layer 3 (L3) of a layered protocol stack. Failures in this kind of network can affect either nodes or links. Identifying a link failure is straightforward in most cases. On the other hand, diagnosing a node failure might be simple, but can be extremely complicated.

Any number of problems can cause failures, anything from a physical link breaking or a fan malfunctioning through to code executing erroneously.

Congestion could be viewed as a special case of failure, due to a heavy load on a link or a node. The nature of congestion is, however, often transient.

In any layered network model, failures can be understood as relating to a certain layer. Each layer has some capability to cope with failures. If a particular layer is unable to overcome a failure, that layer typically reports the failure to a higher layer that may have additional capabilities for coping with the failure. For example, if a physical link between two nodes is broken, it is possible to have another link on standby and switch the traffic over to this other link. If the link control logic (L2) fails, it is possible to have an alternate in place. If all of these methods are unable to resolve the problem, the failure is passed on to the network layer (L3).

In the context of the disclosed bypass mechanism, it is advantageous for lower layers to be able to handle a failure. However, certain failures cannot be remedied by the lower layers, and must be remedied at L3. The disclosed bypass mechanism is designed to remedy only those failures that absolutely have to be resolved by the network layer (L3).

In the type of network to which the disclosed bypass mechanism is typically applied, there may be failures that originate either in a node or a link. A node/link failure may be total or partial. As mentioned previously, it is not necessarily trivial to correctly identify the link or the node that is the source of the failure.

A total L3 link failure may occur when, for example, a link is physically broken (the back-hoe or excavator case), the RJ11 connector is pulled out, or some equipment supporting the link is broken. A total link failure is generally easy to detect and diagnose.

A partial link failure may occur when, for example, certain conditions make the link behave as if it is broken at one time and working at another time. For example, an adverse EMC environment near an electrical link may cause a partial link failure by creating a high bit error rate. The same behavior might be the cause of transient congestion.

A total node failure results in a complete inability of the node to perform L3 functions. A total node failure may occur, for example, when a node loses power or otherwise resets.

A partial node failure occurs when some, but not all, node functions fail. A partial node failure may occur, for example, when a subsystem in a router is behaving erroneously while the rest of the router is behaving correctly. It is, for example, possible for hardware-based forwarding be operational while the underlying routing software is inoperative due to a software failure. Reliably diagnosing a partial node failure is difficult, and is outside the scope of the present invention. Generally speaking, it is difficult to differentiate between a node failure and a link failure. For example, detecting a node failure may require correlation of multiple apparent link failures detected by several nodes. Therefore, the disclosed bypass mechanism typically treats all failures in the same manner without differentiating between different types of failures.

Detecting the Failure (State 2)

When the first router networks were implemented, link stability was a major issue. The high bit error rates that could occur on the long distance serial links, which were used, was a serious source of link instability. TCP was developed to overcome this, creating an end to end transport control.

To detect link failures, a solution with a KeepAlive message and RouterDeadInterval was implemented in the network layer. Specifically, routers typically send KeepAlive messages at certain intervals over each interface to which a router peer is connected. If a certain number of these messages get lost, the peer assumes that the link (or the peer router) has failed. Typically, the interval between two KeepAlive messages is 10 seconds and the RouterDeadInterval is three times the KeepAlive interval.

The combination of TCP and KeepAlive/RouterDeadInterval on one hand made it possible to have communication over comparatively poor links and at the same time overcome a problem commonly referred to as the route flapping problem (where routers are frequently recalculating their forwarding tables).

As the quality of link layers has improved and the speed of links has increased, it has become worthwhile to decrease the interval between the KeepAlives. Because of the amount of generated traffic and the processing of KeepAlives in software, it is not generally feasible to use a KeepAlive interval shorter than approximately 1 second. This KeepAlive/RouterDeadInterval is still too slow for detecting failures.

Therefore, the disclosed bypass mechanism preferably uses a fast detection detection protocol, referred to as the Fast LIveness Protocol (FLIP), that is able to detect L3 failures in typically no more than 50 ms (depending on the bandwidth of the link being monitored). FLIP is described in an Internet Engineering Task Force (IETF) Internet Draft document entitled Fast Llveness Protocol (FLIP), draft-sandiick-flip-00 (February 2000), which is hereby incorporated herein by reference in its entirety. FLIP is designed to work with hardware support in the router forwarding (fast) path, and is able to detect a link failure substantially as fast as technologies based on lower layers (on the order of milliseconds). Although FLIP is useful generally for quickly detecting network failures, FLIP is particularly useful when used in conjunction with lower layer technologies that do not have the ability to escalate failures to L3.

In order to detect a failure, the disclosed bypass mechanism uses various criteria to characterize the link. In an exemplary embodiment of the invention, each link is characterized by indispensability and hysteresis parameters.

Hysteresis determines the criteria for declaring when a link has failed and when a failed link has been restored. The criteria for declaring a failure might be significantly less aggressive than those for declaring the link operative again. For example, a link may be considered failed if three consecutive FLIP messages are lost, but may be considered operational only after a much larger number of messages have been successfully received consecutively. By requiring a larger number of successful messages following a failure, such hysteresis reduces the likelihood of declaring the link operational and quickly declaring the link failed again.

Indispensability is used to determine various thresholds for declaring a failure. For example, a link that is the only connectivity to a particular location might be kept in operation by relaxing the failure detection.

It should be noted that FLIP may be extended to detect at least a subset of the possible node failures.

It should also be noted that the ability of the described bypass mechanism to detect link failures so rapidly could cause interaction problems with lower layers unless such interaction problems are correctly designed into the network. For example, the network should be designed so that the described bypass mechanism detects a failure only after lower layer repair mechanisms have had a chance to complete their repairs.

Signaling the Failure (State 3)

Many existing and proposed path and link protection schemes are such that the detecting node does not necessarily perform the switch over. Rather, the node that detects the failure signals the other nodes, and all nodes establish new routes to bypass the failure. This requires a signaling protocol to distribute the failure indication between the nodes. It also increases the time from failure detection to switch over to the recovery paths.

Although the detecting node may signal the other nodes when the failure is detected, it is preferable for the detecting node to perform the switch over itself. Thus, there is no “signaling” per se. The “signaling” in this case is typically a simple sub-routine call in order to initiate the switch over to the recovery paths. The “signaling” may even be supported directly in the hardware that is used to detect the failure. Such a scheme is markedly superior both as to speed and complexity compared to the other schemes.

Switch-over (State 4)

In this state, communications are switched from the primary path to the recovery path in order to bypass the network failure. The recovery path is activated, and some or all of the traffic from the failed primary path is diverted to the recovery path. Because the recovery path is pre-computed, this switch over to the recovery path can generally be completed quite quickly (typically within 100 milliseconds from the time the failure occurs, assuming a fast mechanism such as FLIP is used to detect L3 failures and the detecting node performs the switch over). After the switch over to the recovery path is completed, traffic affected by the failure flows over the recovery path, while the rest of the traffic remains on the primary paths defined by the routing protocols or traffic engineering before the failure occurred.

In an exemplary embodiment of the invention, switch over to the recovery paths is typically accomplished by removing the primary (failed) path from the forwarding tables, blocking the primary (failed) path from the forwarding tables, or marking the recovery path as a higher priority path than the primary path in the forwarding tables. Because the recovery path is already installed in the forwarding tables, the node begins using the recovery path when the primary route becomes unavailable.

In this state, it is unclear how the network will behave in general, and it is unclear how long the network can tolerate this state vis-à-vis congestion, loss, and excessive delay to both the diverted and non-diverted traffic. While the network is in the semi-stable state, there will likely be competition for resources on the recovery paths.

One approach to cope with such competition for resources on the recovery paths is to do nothing at all. If the recovery path becomes congested, packets will be dropped without considering whether they are part of the diverted or non-diverted traffic. This method is conceivable in a network where traffic is not prioritized while the network is in protected state. This approach is simple, and there is a high probability that it will work well if the time while the network is in the semi-stable state is short. However, there is no control over which traffic is dropped, and the amount of traffic that is retransmitted by higher layers could be high.

Another approach to cope with such competition for resources on the recovery paths is to switch only some of the traffic from the primary path to the recovery path, for example, based upon a predetermined priority scheme. In this way, when the switch over to the recovery path takes place, only traffic belonging to certain priority classes is switched over to the recovery path, while the rest is typically discarded or turned over to a second-order protection mechanism, such as conventional routing convergence. A strength of this scheme is that it is fast and effective, whilst at the same time it is possible to protect the highest priority traffic. A weakness is that the prioritization has to be pre-configured and, even if there is capacity to protect much of the traffic that is being dropped, this typically cannot be done ‘on the fly’.

One priority scheme uses IETF Differentiated Services markings to decide how the packets should be treated by the queuing mechanisms and which packets should be dropped or turned over to the second-order protection mechanism. IETF Differentiated Services are described in an Internet Engineering Task Force (IETF) Request For Comments (RFC) 2475 entitled An Architecture for Differentiated Services by S. Blake et al. dated December 1998, which is hereby incorporated herein by reference in its entirety. Internet Protocol (IP) support for differentiated services is described in an Internet Engineering Task Force (IETF) Request For Comments (RFC) 2474 entitled Definition of the Differentiated Services Field (DS Field) in the IPv4 and IPv6 Headers by K. Nichols et al. dated December 1998, which is hereby incorporated herein by reference in its entirety. The interaction of differentiated services with IP tunnels is discussed in an Internet Engineering Task Force (IETF) Request For Comments (RFC) 2983 entitled Differentiated Services and Tunnels by D. Black dated October 2000, which is hereby incorporated herein by reference in its entirety. MPLS support for differentiated services is described in an Internet Engineering Task Force (IETF) internet draft document draft-ietf-mpls-diff-ext-07.txt entitled MPLS Support of Differentiated Services by Francois Le Faucheur et al. dated August 2000, which is hereby incorporated herein by reference in its entirety, and describes various ways of mapping between LSPs and the DiffServ per hop behavior (PHB), which selects the prioritization given to the packets.

In one mapping, the three bit experimental (EXP) field of the MPLS Shim Header conveys to the Label Switching Router (LSR) the PHB to be applied to the packet (covering both information about the packet's scheduling treatment and its drop precedence). The eight possible values are valid within a DiffServ domain. In the MPLS standard, this type of LSP is called EXP-Inferred-PSC (PHB Scheduling Class) LSP (E-LSP).

In another mapping, packet scheduling treatment is inferred by the LSR exclusively from the packet's label value while the packet's drop precedence is conveyed in the EXP field of the MPLS Header or in the encapsulating link layer specific selective drop mechanism (ATM, Frame Relay, 802.1). In the MPLS standard, this type of LSP is called Label-Only-Inferred-PSC LSP (L-LSP).

In the context of the disclosed bypass mechanism, the use of E-LSPs is the most straightforward. The PHB in an EXP field of an LSP that is to be sent on a recovery path tunnel is copied to the EXP field of the tunnel label. For traffic forwarded on the L3 header, the information in the DS byte is mapped to the EXP field of the tunnel.

Some strengths of the DiffServ approach are that it uses a mechanism that is likely to be present in the system for other reasons, traffic forwarded on the basis of the IP header and traffic forwarded through MPLS LSPs will be equally protected, and the amount of traffic that is potentially protected is high. A weakness of the DiffServ approach is that a large number of LSPs will be needed, especially for the L-LSP scenario.

Yet another approach to cope with such competition for resources on the recovery paths is to explicitly request resources when the recovery paths are set up. In this case, the traffic that was previously using the link that will be used for protection of prioritized traffic has to be dropped when the network enters the semi-stable state.

FIG. 8 shows exemplary logic 800 for performing a switch over from the primary path to the recovery path. Beginning at block 802, the logic may remove the primary path from the forwarding table, in block 804, block the primary path in the forwarding table, in block 806, or mark the recovery path as a higher priority path than the primary path in the forwarding table, in block 808, in order to inactivate the primary path and activate the recovery path. The logic may switch communications from the primary path to the recovery path based upon a predetermined priority scheme, in block 810. The logic 800 terminates in block 899.

Dynamic Routing Protocols Converge (States 5-7)

In an IP routed network, distributed calculations are performed in all nodes independently to calculate the connectivity in the routing domain (and the interfaces entering/leaving the domain). Both of the common intra-domain routing protocols used in IP networks (OSPF and Integrated IS-IS) are link state protocols, which build a model of the network topology through exchange of connectivity information with their neighbors. Given that routing protocol implementations are correct (i.e. according to their specifications), all nodes will converge on the same view of the network topology after a number of exchanges. Based on this converged view of the topology, routing/forwarding tables will be produced by each node in the network to control the forwarding of packets through that node, taking into consideration each node's particular position in the network. Consequently, the routing/forwarding tables at each node can be quite different after the failure than before the failure depending on how route aggregation is affected.

The behavior of the link state protocol during this convergence process can be divided into four phases, specifically failure occurrence, failure detection, topology flooding, and forwarding table recalculation.

As discussed above, there are different types of failures (link, node) that can occur for various reasons. The disclosed bypass mechanism is intended for bypassing only those failures that be remedied by the IP routing protocol or the combination of the IP routing protocol and MPLS protocols, and failures that are able to be repaired by lower layers should be handled by those layers.

For the disclosed bypass mechanism, FLIP is used to detect link failures. FLIP is able to detect a link failure as fast as technologies based on lower layers, viz. within a few milliseconds. When L3 is able to detect link failures at that speed, interoperation with the lower layers becomes an issue, and has to be designed into the network.

When a router detects a change in the network topology (link failure, node failure, or an addition to the network), the information is communicated to its L3 peers within the routing domain. In link state routing protocols such as OSPF and Integrated IS-IS, the information is typically carried in Link State Advertisements (LSAs) that are ‘flooded’ through the network. The information is used to create a link state database (LSDB) that models the topology of the network in the routing domain. The flooding mechanism makes sure that every node in the network is reached and that the same information is not sent over the same interface more than once.

LSA's might be sent in a situation where the network topology is changing and they are processed in software. For this reason, the time from the instant at which the first LSA resulting from a topology change is sent out until it reaches the last node might be in the order of seconds.

Therefore, an exemplary embodiment of the present invention uses fast path forwarding of LSA, for example, as described in the related patent applications that were incorporated by reference above, in order to reduce the amount of time it takes to flood LSAs.

When a node receives new topology information, it updates its routing database and starts the process of recalculating the forwarding table. Because the recovery path may traverse links that are used for other traffic, it is important for the new routes to be computed as quickly as possible so that traffic can be switched from the recovery path to the new primary paths. Therefore, although it is possible for a node to reduce its computational load by postponing recalculation of the forwarding table until a specified number of updates (typically more than one) are received (or if no more updates are received after a specified timeout), such postponing may increase the amount of time to compute new primary paths. In any case, after the LSAs resulting from a change are fully flooded, the routing database is the same at every node in the network, but the resulting forwarding table is unique to the node.

The information flooding mechanism used in OSPF and Integrated IS-IS does not involve signaling of completion and timeouts used to suppress multiple recalculations. This, together with the considerable complexity of the forwarding calculation, may cause the point in time at which each node in the network starts using its new forwarding table to vary significantly between the nodes.

From the point in time at which the failure occurs until all the nodes have started to use their new forwarding tables, there might be a failure to deliver packets to the correct destination. Traffic intended for a next hop on the other side of a broken link or for a next hop that is broken may be lost. The information in the different generations of forwarding tables can be inconsistent and cause forwarding loops and invalid routes. The Time to Live (TTL) in the IP packet header will then cause the packet to be dropped after a pre-configured number of hops.

New Primary Paths are Established (States 5-7)

While the network is in a semi-stable state, the forwarding tables are frozen while new primary paths are computed in the background. The new primary paths are preferably not activated independently, but are instead activated in a coordinated way across the routing domain.

Once the routing databases have been updated with new information, the routing update process is irreversible. That is, the path recalculation processes will start and a new forwarding table will be created for each node.

If MPLS traffic is used in the network for other purposes than protection, the LSPs also have to be established before the new forwarding tables can be put into operation. The LSPs could be established by any of a variety of mechanisms, including LDP, CR-LDP, RSVP-TE, or alternatives or combinations thereof.

New Recovery Paths are Established

After the primary paths have been established, new recovery paths are typically established as described above. This is because an existing recovery path may have become non-optimal or even non-functional by virtue of the switch over to the new primary routes. For example, if the routing protocol will route traffic through node A that formerly was routed through node B, then node A has to establish new recovery paths for this traffic and node B has to remove old recovery paths.

The recovery paths may be computed before or after the switch over to the new primary paths. Whether the recovery paths are computed before of after the switch over to the new primary paths is network/solution dependent. If the traffic is switched over before the recovery path is established, this will create a situation where the network is unprotected. If the traffic is switched over after the recovery paths has been established, then the duration for which the traffic stays on the recovery paths might cause congestion problems.

Traffic Switched to New Primary Paths (State 8)

In traditional routed IP network, the forwarding tables will be used as soon as they are available in each single node. As discussed above, this can cause certain problems such as misrouted traffic and forwarding loops.

In an exemplary embodiment of the invention, activation of the new primary paths is coordinated such that all nodes begin using the new primary paths at substantially the same time. This coordination can be accomplished various ways, and the present invention is in no way limited to any particular mechanism for coordinating the activation of the primary paths by the nodes in the network.

One mechanism for coordinating the activation of the primary paths by the nodes in the network is through the use of timers to defer the deployment of the new forwarding tables until a pre-defined time after the first LSA indicating the failure is sent. Specifically, a node that detects the network failure sends a LSA identifying the failure and starts a timer. Each node that receives the LSA starts a timer. The timers are typically set to a predetermined amount of time, although the timers could also be set to a predetermined absolute time (e.g., selected by the node that detects the failure and distributed within the LSA. In any case, the timer is typically selected based upon the size of the network in order to give all nodes sufficient time to obtain all routing information and compute new primary paths. All nodes proceed to exchange routing information with the other nodes and compute the new primary paths. Each node activates the new primary paths when its corresponding timer expires.

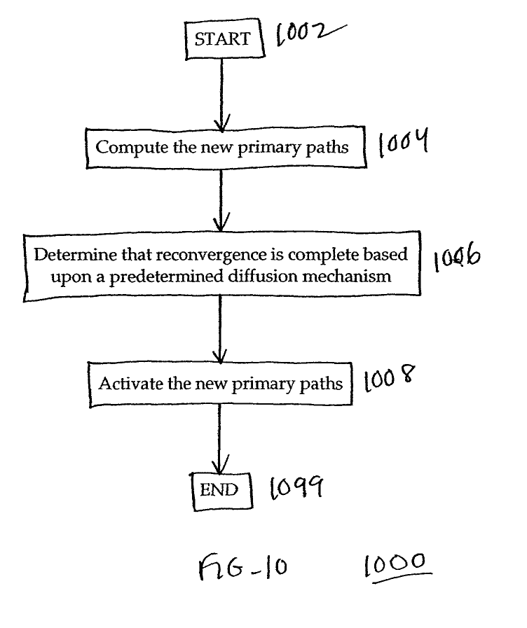

FIG. 9 shows exemplary logic 900 for coordinating activation of the new primary paths using timers. Beginning at block 902, the logic receives a LSA including updated routing information, in block 904. Upon receiving the LSA, in block 904, the logic starts a timer, in block 906. The logic continues exchanging routing information with the other nodes, and computes new primary paths, in block 908. The logic waits for the timer to expire before activating the new primary paths. Upon determining that the timer has expired, in block 910, the logic activates the new primary paths, in block 912. The logic 900 terminates in block 999.

Another mechanism for coordinating the activation of the primary paths by the nodes in the network is through the use of a diffusion mechanism that calculates when the network is loop free. Each node computes new primary paths, and uses a diffusion mechanism to determine when reconvergence is complete for all nodes. Each node activates the new primary paths upon determining that reconvergence is complete.

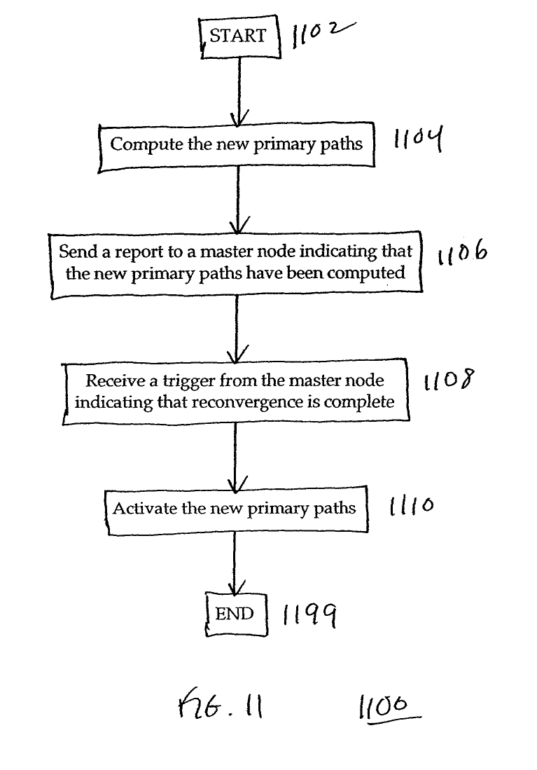

FIG. 10 shows exemplary logic 1000 for coordinating activation of the new primary paths using a diffusion mechanism. Beginning at block 1002, the logic exchanges routing information with the other nodes, and computes new primary paths, in block 904. The logic uses a predetermined diffusion mechanism for determining when reconvergence is complete (i.e., that all nodes have computed new primary paths). Upon determining that reconvergence is complete based upon the predetermined diffusion mechanism, in block 1006, the logic activates the new primary paths, in block 1008. The logic 1000 terminates in block 1099.

Yet another mechanism for coordinating the activation of the primary paths by the nodes in the network is through signaling from a master node. Within the network, a specific node is designated as the master node for signaling when reconvergence is complete, and the other nodes are considered to be slave nodes. All nodes compute new primary routes. Each slave node sends a report to the master node when it completes its computation of the new primary paths. The master node awaits reports from all slave nodes (which are typically identified from the topology information exchanged using the routing protocol), and then sends a trigger to the slave nodes indicating that reconvergence is complete. The slave nodes activate the new primary routes upon receiving the trigger from the master node.

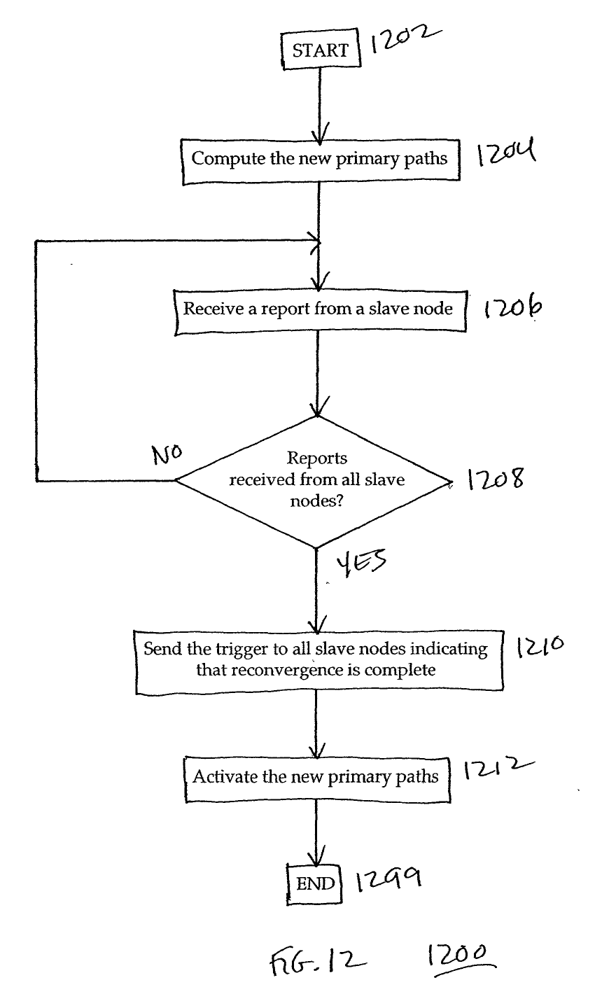

FIG. 11 shows exemplary logic 1100 for coordinating activation of the new primary paths by a slave node. Beginning at block 1102, the logic exchanges routing information with the other nodes, and computes new primary paths, in block 1104. When complete, the logic sends a report to a master node indicating that the new primary paths have been computed, in block 1106. The logic then awaits a trigger from the master node indicating that reconvergence is complete. Upon receiving the trigger from the master node, in block 1108, the logic activates the new primary paths, in block 1110. The logic 1100 terminates in block 1199.

FIG. 12 shows exemplary logic 1200 for coordinating activation of the new primary paths by a master node. Beginning at block 1202, the logic exchanges routing information with the other nodes, and computes new primary paths, in block 1204. The logic awaits reports from all slave nodes. Upon receiving a report from a slave node, in block 1206, the logic determines whether reports have been received from all slave nodes, in block 1208. If reports have not been received from all slave nodes (NO in block 1208), then the logic recycles to block 1206 to receive a next report. If reports have been received from all slave nodes (YES in block 1208), then the logic sends a trigger to all slave nodes indicating that reconvergence is complete, in block 1210, and activates the new primary paths, in block 1212. The logic 1200 terminates in block 1299.

It should be noted that the disclosed bypass mechanism is not intended to be a replacement for all other traffic protection mechanisms. There are a number of different proposals for traffic protection, from traditional lower layer capabilities to more recent ones based on fast L3 link/node failure detection and MPLS. The disclosed bypass mechanism is complementary to other traffic protection mechanisms and addresses a problem space where other proposals or solutions are not fully effective.

It should be noted that the term “router” is used herein to describe a communication device that may be used in a communication system, and should not be construed to limit the present invention to any particular communication device type. Thus, a communication device may include, without limitation, a gateway, bridge, router, bridge-router (brouter), switch, node, or other communication device.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the described logic is implemented as a set of computer program instructions that is converted into a computer executable form, stored as such in a computer readable medium, and executed by a microprocessor within the network node under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies, networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

We claim:

1. A method for bypassing a network change by a node in a communication network, the method comprising:
pre-determining a recovery path for bypassing a network change that affects communications over a primary path;
detecting the network change that affects communications over the primary path; and
switching communications from the primary path to the recovery path in order to bypass the network change.

2. The method of claim 1, wherein pre-determining the recovery path for bypassing the network change comprises:
establishing as the recovery path a label switched path that bypasses the network change.

3. The method of claim 1, wherein pre-determining the recovery path for bypassing the network change comprises:
logically introducing the network change into a routing database; and
determining the recovery path based upon a pre-determined path determination scheme.

4. The method of claim 3, wherein the pre-determined path determination scheme comprises a shortest-path-first computation.

5. The method of claim 1, wherein pre-determining the recovery path for bypassing the network change comprises:
installing the recovery path in a forwarding table.

6. The method of claim 1, wherein detecting the network change that affects communications over the primary path comprises:
using a fast liveness protocol to detect the network change.

7. The method of claim 1, wherein the network change comprises a link failure.

8. The method of claim 1, wherein the network change comprises a node failure.

9. The method of claim 1, wherein the network change comprises a routing change.

10. The method of claim 1, wherein switching communications from the primary path to the recovery path in order to bypass the network change comprises:
activating the recovery path.

11. The method of claim 10, wherein activating the recovery path comprises:
removing the primary path from a forwarding table.

12. The method of claim 10, wherein activating the recovery path comprises:
blocking the primary path in a forwarding table.

13. The method of claim 10, wherein activating the recovery path comprises:
marking the recovery path as a higher priority path than the primary path in a forwarding table.

14. The method of claim 1, wherein switching communications from the primary path to the recovery path in order to bypass the network change comprises:
forwarding all communications from the primary path over the recovery path.

15. The method of claim 1, wherein switching communications from the primary path to the recovery path in order to bypass the network change comprises:
forwarding some communications from the primary path over the recovery path based upon a predetermined priority scheme.

16. The method of claim 15, wherein the predetermined priority scheme comprises an IP Differentiated Services scheme.

17. The method of claim 1, further comprising:
determining a new primary path.

18. The method of claim 17, wherein determining the new primary path comprises:
receiving routing information; and
computing the new primary path based upon the routing information.

19. The method of claim 17, further comprising:
activating the new primary path.

20. The method of claim 19, further comprising:
switching communications from the recovery path to the new primary path after activating the new primary path.

21. The method of claim 19, wherein determining the new primary path and activating the new primary path comprise:
freezing a forwarding table after switching communications from the primary path to the recovery path;
computing the new primary path while the forwarding table is frozen; and
coordinating activation of the new primary path with at least one other node in the communication network.

22. The method of claim 21, wherein coordinating activation of the new primary path with at least one other node in the communication network comprises:
using a timer to determine when to activate the new primary path.

23. The method of claim 21, wherein coordinating activation of the new primary path with at least one other node in the communication network comprises:
using a predetermined diffusion mechanism to determine when to activate the new primary path.

24. The method of claim 21, wherein coordinating activation of the new primary path with at least one other node in the communication network comprises:
receiving a signal from a master node; and
activating the new primary path upon receiving the signal from the master node.

25. The method of claim 21, wherein coordinating activation of the new primary path with at least one other node in the communication network comprises:
receiving signals from a number of slave nodes;
determining that the number of slave nodes have completed computing new primary paths; and
activating the new primary path upon determining that the number of slave node have completed computing new primary paths.

26. The method of claim 25, further comprising:
sending a signal to the number of slave nodes.

27. The method of claim 17, further comprising:
computing a new recovery path to protect the new primary path.

28. The method of claim 19, further comprising:
computing a new recovery path after activating the new primary path.

29. A device for bypassing a network change in a communication network, the device comprising:
recovery path logic operably coupled to pre-determine a recovery path for bypassing a network change that affects communications over a primary path;
detection logic operably coupled to detect the network change that affects communications over the primary path; and
switching logic operably coupled to switch communications from the primary path to the recovery path in order to bypass the network change.

30. The device of claim 29, wherein the recovery path logic is operably coupled to establish as the recovery path a label switched path that bypasses the network change.

31. The device of claim 29, wherein the recovery path logic is operably coupled to logically introduce the network change into a routing database and determine the recovery path based upon a pre-determined path determination scheme.

32. The device of claim 31, wherein the pre-determined path determination scheme comprises a shortest-path-first computation.

33. The device of claim 29, wherein the recovery path logic is operably coupled to install the recovery path in a forwarding table.

34. The device of claim 29, wherein the detection logic is operably coupled to use a fast liveness protocol to detect the network change.

35. The device of claim 29, wherein the network change comprises a link failure.

36. The device of claim 29, wherein the network change comprises a node failure.

37. The device of claim 29, wherein the network change comprises a routing change.

38. The device of claim 29, wherein the switching logic is operably coupled to activate the recovery path in order to switch communications from the primary path to the recovery path.

39. The device of claim 38, wherein the switching logic is operably coupled to remove the primary path from a forwarding table in order to activate the recovery path.

40. The device of claim 38, wherein the switching logic is operably coupled to block the primary path in a forwarding table in order to activate the recovery path.

41. The device of claim 38, wherein the switching logic is operably coupled to mark the recovery path as a higher priority path than the primary path in a forwarding table in order to activate the recovery path.

42. The device of claim 29, wherein the switching logic is operably coupled to forward all communications from the primary path over the recovery path.

43. The device of claim 29, wherein the switching logic is operably coupled to forward some communications from the primary path over the recovery path based upon a predetermined priority scheme.

44. The device of claim 43, wherein the predetermined priority scheme comprises an IP Differentiated Services scheme.

45. The device of claim 29, further comprising:
reconvergence logic operably coupled to determine a new primary path.

46. The device of claim 45, wherein the reconvergence logic is operably coupled to receive routing information and compute the new primary path based upon the routing information.

47. The device of claim 45, wherein the reconvergence logic is operably coupled to activate the new primary path.

48. The device of claim 47, wherein the switching logic is operably coupled to switch communications from the recovery path to the new primary path upon activation of the new primary path.

49. The device of claim 47, wherein the reconvergence logic is operably coupled to freeze a forwarding table during computation of the new primary path and coordinate activation of the new primary path with at least one other node in the communication network.

50. The device of claim 49, wherein the reconvergence logic is operably coupled to use a timer to determine when to activate the new primary path.

51. The device of claim 49, wherein the reconvergence logic is operably coupled to use a predetermined diffusion mechanism to determine when to activate the new primary path.

52. The device of claim 49, wherein the reconvergence logic is operably coupled to receive a signal from a master node and activate the new primary path upon receiving the signal from the master node.

53. The device of claim 49, wherein the reconvergence logic is operably coupled to activate the new primary path upon determining that a number of slave nodes have completed computing new primary paths based upon signals received from the number of slave nodes.

54. The device of claim 53, wherein the reconvergence logic is operably coupled to send a signal to the number of slave nodes upon determining that the number of slave nodes have completed computing new primary paths.

55. The device of claim 45, wherein the recovery logic is operably coupled to compute a new recovery path to protect the new primary path.

56. The device of claim 47, wherein the recovery logic is operably coupled to compute a new recovery path after activation of the new primary path.

57. A computer program for programming a computer system to bypass a network change in a communication network, the computer program comprising:
recovery path logic programmed to pre-determine a recovery path for bypassing a network change that affects communications over a primary path;
detection logic programmed to detect the network change that affects communications over the primary path; and
switching logic programmed to switch communications from the primary path to the recovery path in order to bypass the network change.

58. The computer program of claim 57, wherein the recovery path logic is programmed to establish as the recovery path a label switched path that bypasses the network change.

59. The computer program of claim 57, wherein the recovery path logic is programmed to logically introduce the network change into a routing database and determine the recovery path based upon a pre-determined path determination scheme.

60. The computer program of claim 59, wherein the predetermined path determination scheme comprises a shortest-path-first computation.

61. The computer program of claim 57, wherein the recovery path logic is programmed to install the recovery path in a forwarding table.

62. The computer program of claim 57, wherein the detection logic is programmed to use a fast liveness protocol to detect the network change.

63. The computer program of claim 57, wherein the network change comprises a link failure.

64. The computer program of claim 57, wherein the network change comprises a node failure.

65. The computer program of claim 57, wherein the network change comprises a routing change.

66. The computer program of claim 57, wherein the switching logic is programmed to activate the recovery path in order to switch communications from the primary path to the recovery path.

67. The computer program of claim 66, wherein the switching logic is programmed to remove the primary path from a forwarding table in order to activate the recovery path.

68. The computer program of claim 66, wherein the switching logic is programmed to block the primary path in a forwarding table in order to activate the recovery path.

69. The computer program of claim 66, wherein the switching logic is programmed to mark the recovery path as a higher priority path than the primary path in a forwarding table in order to activate the recovery path.

70. The computer program of claim 57, wherein the switching logic is programmed to forward all communications from the primary path over the recovery path.

71. The computer program of claim 57, wherein the switching logic is programmed to forward some communications from the primary path over the recovery path based upon a predetermined priority scheme.

72. The computer program of claim 71, wherein the predetermined priority scheme comprises an IP Differentiated Services scheme.

73. The computer program of claim 57, further comprising:
reconvergence logic programmed to determine a new primary path.

74. The computer program of claim 73, wherein the reconvergence logic is programmed to receive routing information and compute the new primary path based upon the routing information.

75. The computer program of claim 73, wherein the reconvergence logic is programmed to activate the new primary path.

76. The computer program of claim 75, wherein the switching logic is programmed to switch communications from the recovery path to the new primary path upon activation of the new primary path.

77. The computer program of claim 75, wherein the reconvergence logic is programmed to freeze a forwarding table during computation of the new primary path and coordinate activation of the new primary path with at least one other node in the communication network.

78. The computer program of claim 77, wherein the reconvergence logic is programmed to use a timer to determine when to activate the new primary path.

79. The computer program of claim 77, wherein the reconvergence logic is programmed to use a predetermined diffusion mechanism to determine when to activate the new primary path.

80. The computer program of claim 77, wherein the reconvergence logic is programmed to receive a signal from a master node and activate the new primary path upon receiving the signal from the master node.

81. The computer program of claim 77, wherein the reconvergence logic is programmed to activate the new primary path upon determining that a number of slave nodes have completed computing new primary paths based upon signals received from the number of slave nodes.

82. The computer program of claim 81, wherein the reconvergence logic is programmed to send a signal to the number of slave nodes upon determining that the number of slave nodes have completed computing new primary paths.

83. The computer program of claim 73, wherein the recovery logic is programmed to compute a new recovery path to protect the new primary path.

84. The computer program of claim 75, wherein the recovery logic is programmed to compute a new recovery path after activation of the new primary path.

85. The computer program of claim 57 embodied in a computer readable medium.

86. The computer program of claim 57 embodied in a data signal.

87. A communication system comprising a plurality of interconnected communication nodes, wherein primary paths are established for forwarding information and recovery paths are pre-computed for bypassing potential primary path failures.

88. The communication system of claim 87, wherein communications are switched from a primary path to a recovery path in order to bypass a network change.

89. The communication system of claim 88, wherein new primary paths are determined after communications are switched from the primary path to the recovery path, and communications are switched from the recovery path to a new primary path.

90. The communication system of claim 89, wherein each communication node freezes a forwarding table before determining new primary paths.

91. The communication system of claim 89, wherein new recovery paths for protecting the new primary paths are computed before switching communications from the recovery path to the new primary path.

92. The communication system of claim 89, wherein new recovery paths for protecting the new primary paths are computer after switching communications from the recovery path to the new primary path.

93. A method for reconverging routes in a communication network, the method comprising:
determining that a route change is needed;
freezing forwarding tables so that a predetermined set of routes is used during reconvergence; and
reconverging on a new set of routes while the forwarding tables are frozen.

94. The method of claim 93, further comprising:
activating the new set of routes in a coordinated manner.

95. The method of claim 94, wherein activating the new set of routes in a coordinated manner comprises:
starting a timer by each of a number of nodes in the communication network upon determining that reconvergence is needed; and
activating the new set of routes by each of the number of nodes upon expiration of the timer.

96. The method of claim 94, wherein activating the new set of routes in a coordinated manner comprises:
using a predetermined diffusion mechanism by each of the number of nodes to determine when reconvergence is complete; and
activating the new set of routes by each of the number of nodes upon determining that reconvergence is complete.

97. The method of claim 94, wherein activating the new set of routes in a coordinated manner comprises:
designating one of the number of nodes as a master node and designating the remaining nodes as slave nodes;
sending a first signal by each of the slave nodes to the master node upon reconverging on the new set of routes; and
sending a second signal by the master node to the slave nodes upon receiving the first signal from each of the slave nodes.

98. A use of a bypass mechanism for bypassing a network change in a communication network, the use comprising:
using the bypass mechanism to pre-compute a recovery path for bypassing a network change affecting communication over a primary path, detect the network change affecting communication over the primary path, and switch communications from the primary path to the pre-computed recovery path upon detecting said network change.

99. The use of claim 98, further comprising:
using the bypass mechanism to compute a new primary path after switching communications from the primary path to the pre-computed recovery path; and
using the bypass mechanism to switch communications from the pre-computed recovery path to the new primary path.

100. The use of claim 99, further comprising:
using the bypass mechanism to compute a new recovery path for bypassing a network change affecting communication over the new primary path.
